(19) United States
(12) Patent Application Publication
(10) Pub. No.: US 2006/0268034 A1
(43) Pub. Date: Nov. 30, 2006

(54) Method of compensating for a defective nozzle in an ink-jet image forming apparatus

(76) Inventors: In-su Lee, Seoul (KR); Myung-song Jung, Gunpo-si (KR)

Correspondence Address: STANZIONE & KIM, LLP, 919 18TH STREET, N.W., SUITE 440, WASHINGTON, DC, 20006, US

(21) Appl. No.: 11/354,992

(22) Filed: Feb. 16, 2006

(30) Foreign Application Priority Data
May 25, 2005 (KR) 2005-44229

(51) Int. Cl. B41J 29/38

(52) U.S. Cl. 347/12

(57) ABSTRACT

A method of compensating for a defective nozzle in an ink-jet image forming apparatus. The method includes detecting a defective nozzle in a nozzle unit, and if the defective nozzle is detected, and compensating for the defective nozzle by using a compensating nozzle unit to eject a colorless ink droplet. The method can compensate for a printing defect, such as a white line which can be easily noticed by a user, using colorless ink droplets. In addition, the method can compensate for a defective nozzle that ejects color ink as well as a defective nozzle that ejects black ink. Also, the method can improve a compensation effect by adjusting a size or an arrangement of the compensating nozzle unit.

### CROSS-REFERENCE TO RELATED APPLICATIONS

This application claims the benefit of Korean Patent Application No. 2005-44229, filed on May 25, 2005, in the Korean Intellectual Property Office, the disclosure of which is incorporated herein in its entirety by reference.

### BACKGROUND OF THE INVENTION

1. Field of the Invention

The present general inventive concept relates to an ink-jet image forming apparatus, and more particularly, to a method of compensating for a defective nozzle in an ink-jet image forming apparatus in which a missing dot or a white line that would appear due to defective nozzles that poorly eject ink droplets or weak nozzles that cannot eject ink droplets properly is compensated for.

2. Description of the Related Art

An ink-jet image forming apparatus is a device that forms an image by ejecting ink droplets on a recording medium. The ink-jet image forming apparatus includes a printhead having a nozzle unit provided with a plurality of nozzles for ejecting ink droplets. If any one of the nozzles fails to eject ink droplets, a white line or a missing line due to a line of missing dots appears in a printed image on the recording medium.

FIG. 1 illustrates a printing pattern due to a defective nozzle in a conventional ink-jet image forming apparatus, and FIGS. 2A through 2D illustrate a conventional method of compensating for a defective nozzle in the conventional ink-jet image forming apparatus.

Referring to FIG. 1, the conventional ink-jet image forming apparatus forms an image on a recording medium by ejecting ink droplets on the recording medium from a plurality of nozzles 82 in a nozzle unit 80. The nozzle unit 80 is installed in a printhead along a direction that is perpendicular to a conveying direction of the recording medium so that ink droplets are ejected on the recording medium to form the image. A defective nozzle 84 fails to eject ink droplets onto the recording medium. Hence, a missing line due to missing dots appears in the printed image on the recording medium, as illustrated in FIG. 1. A resulting printing defect does not matter when an image of a low printing density is formed. However, when a solid pattern or an image of high printing density is being printed, a white line may appear in the printed image along the conveying direction of the recording medium, thereby remarkably affecting the printing quality.

A conventional method of preventing printing quality deterioration caused by defective nozzles is described in U.S. Pat. No. 5,581,284, of which FIGS. 3 through 6 correspond to FIGS. 2A through 2D in the present application.

The conventional method compensates for a defective nozzle 63 in an ink-jet image forming apparatus. Herein, the defective nozzle 63 refers to a missing nozzle, a nozzle that fails to eject ink droplets, or a weak nozzle which does not eject ink droplets properly. The conventional method comprises monitoring each nozzle in each nozzle unit for ejection of black ink droplets, as illustrated in FIG. 2A, and when the defective nozzle 63 is detected, sequentially ejecting ink droplets of other colors, i.e., cyan, magenta, and yellow ink droplets, to fill a missing droplet of black ink with a droplet of other colors of ink. These operations are illustrated in FIGS. 2B, 2C, and 2D. As described above, if the cyan, magenta, and yellow ink droplets are all ejected to the same position in a droplet-on-droplet manner, a black pixel may be represented in the printed image. This is also referred to as a process black or a composite black. Although the above conventional method is useful when a black pixel is to be printed, it is not possible to compensate for pixels of other colors by mixing the other colors. In addition, when only black ink droplets are ejectable in the ink-jet image forming apparatus, the cyan, magenta, and yellow ink nozzles do not operate, and thus the process black cannot be obtained using these nozzles. However, when a color image is printed on the recording medium, i.e., while the cyan, magenta, and yellow ink nozzles are operating, it is possible to compensate for the missing line created by the defective nozzle 63. Also, when one of the compensating nozzles fails, the missing line may be replaced with a color for the process black, i.e., red (yellow+magenta), green (cyan+yellow), blue (cyan+magenta), or the like, thereby significantly affecting the printing quality. In addition, since color ink droplets or mixed ink droplets have to be ejected to compensate for black ink droplets, an amount of color ink used increases, thereby reducing the lifespan of a color ink cartridge.

According to the prior art described above, when the defective nozzle occurs, printing failure, such as a white line, which is easily noticed by a user occurs due to a missing nozzle, a nozzle that fails to eject ink droplets, or a weak nozzle which does not eject ink droplets properly. The printing failure causes problems in an image forming apparatus that pursues high-quality and high-speed printing. Therefore, the print failure should be compensated for in order to improve the printing quality.

### SUMMARY OF THE INVENTION

The present general inventive concept provides a method of compensating for a defective nozzle in an ink-jet image forming apparatus, in which print quality degradation caused by the defective nozzle or a weak nozzle that cannot eject ink droplets properly is minimized.

The present general inventive concept also provides a method of compensating for a defective nozzle in an ink-jet image forming apparatus, in which a limited compensation capability for only black color in the conventional methods can be overcome, and an effect of the defective or missing nozzle on printing quality is minimized.

The present general inventive concept also provides a method of compensating for a defective nozzle in an ink-jet image forming apparatus, in which a lifespan of an ink-jet head unit is extended.

Additional aspects of the present general inventive concept will be set forth in part in the description which follows and, in part, will be obvious from the description, or may be learned by practice of the general inventive concept.

The foregoing and/or other aspects of the present general inventive concept are achieved by providing a method of compensating for a defective nozzle in an ink-jet image forming apparatus having a nozzle unit to eject ink droplets on a recording medium, the method comprising detecting the defective nozzle in the nozzle unit, and if the defective nozzle is detected, compensating for the defective nozzle by using a compensating nozzle unit to eject a colorless ink droplet.

The detecting of the defective nozzle may be performed before a printing operation is performed by the nozzle unit, and light may be irradiated on the nozzle unit to detect the defective nozzle.

The compensating of the defective nozzle may comprise ejecting the colorless ink droplet from the compensating nozzle unit on a portion of the recording medium that corresponds to the defective nozzle before the printing operation is performed by the nozzle unit. Nozzles in the compensating nozzle unit may have diameters that are greater than or equal to diameters of nozzles in the nozzle unit. Also, the nozzles in the compensating nozzle unit may have diameters that are less than or equal to two times the diameters of the nozzles in the nozzle unit.

The compensating nozzle unit and the nozzle unit may be formed on the same chip. The compensating nozzle unit may be arranged such that the recording medium passes thereunder before passing under the nozzle unit as the recording medium is conveyed.

The compensating nozzle unit and the nozzle unit may be formed on separate chips. The compensating nozzle unit may be arranged such that the recording medium passes thereunder before passing under the nozzle unit as the recording medium is conveyed.

The detecting of the defective nozzle may be performed during a printing operation performed by the nozzle unit, and light may be irradiated on the recording medium to detect the defective nozzle.

The compensating for the defective nozzle may comprise ejecting the colorless ink droplet from the compensating nozzle unit while the printing operation is performed and before a color ink droplet would have been ejected on a portion of the recording medium corresponding to the defective nozzle.

The compensating nozzle unit may be arranged such that the recording medium passes under the nozzle unit before passing under the compensating nozzle unit as the recording medium is being conveyed. A detecting unit that irradiates light on the recording medium to detect the defective nozzle may be interposed between the nozzle unit and the compensating nozzle unit.

The nozzle unit may have a length that is greater than or equal to a width of the recording medium.

The compensating nozzle unit may have a length that is greater than or equal to a width of the recording medium.

The foregoing and/or other aspects of the present general inventive concept are also achieved by providing a method of compensating for a defective nozzle in a nozzle unit, the method comprising ejecting a colorless fluid droplet to a position on a recording medium that corresponds to the defective nozzle, and ejecting a color ink droplet adjacent to the position corresponding to the defective nozzle such that the colorless fluid droplet and the color ink droplet bleed together.

The foregoing and/or other aspects of the present general inventive concept are also achieved by providing an apparatus to compensate for a defective nozzle in a nozzle unit of an inkjet image forming device, the apparatus comprising a compensating nozzle unit to eject a colorless fluid droplet to a position on a recording medium that corresponds to the defective nozzle, and the nozzle unit ejects at least one color ink droplet adjacent to the position corresponding to the defective nozzle such that the colorless fluid droplet and the color ink droplet bleed together.

The foregoing and/or other aspects of the present general inventive concept are also achieved by providing an inkjet image forming apparatus, comprising a nozzle unit having a plurality of nozzles to perform a normal printing operation, and a compensating nozzle unit disposed adjacent to the nozzle unit and having a plurality of nozzles to perform a compensating printing operation by ejecting a colorless fluid droplet to a position on a recording medium that corresponds to a defective nozzle in the nozzle unit, wherein the nozzle unit ejects at least one color ink droplet adjacent to the corresponding to the defective nozzle such that the colorless fluid droplet and the color ink droplet bleed together.

The foregoing and/or other aspects of the present general inventive concept are also achieved by providing an inkjet image forming apparatus, comprising a nozzle unit having a plurality of nozzles to eject color ink to a recording medium, and a compensation unit to perform a dispersion operation to the ejected color ink on the recording medium to compensate for a defective nozzle in the nozzle unit when the nozzle unit includes a defective nozzle.

### BRIEF DESCRIPTION OF THE DRAWINGS

These and/or other aspects of the present general inventive concept will become apparent and more readily appreciated from the following description of the embodiments, taken in conjunction with the accompanying drawings of which:

FIG. 1 is a view illustrating a printing pattern that results from a defective nozzle in a conventional ink-jet image forming apparatus;

FIGS. 2A through 2D are views illustrating a conventional method of compensating for a defective nozzle in the conventional ink-jet image forming apparatus;

FIG. 3 is a schematic view illustrating an ink-jet image forming apparatus according to an embodiment of the present general inventive concept;

FIG. 4 is a side view illustrating a printhead unit of the ink-jet image forming apparatus of FIG. 3 according to an embodiment of the present general inventive concept;

FIG. 5 is a top view illustrating a recording medium and the printhead unit of FIG. 4 according to an embodiment of the present general inventive concept;

FIG. 6 is a top view illustrating a recording medium and a printhead unit of FIG. 4 according to another embodiment of the present general inventive concept;

FIG. 7 is a side view illustrating a printhead unit of the ink-jet image forming apparatus of FIG. 3 according to another embodiment of the present general inventive concept;

FIG. 8 is a top view illustrating a recording medium and the printhead unit of FIG. 7 according to an embodiment of the present general inventive concept;

FIGS. 9 and 10 are top views illustrating a recording medium and a printhead unit of the ink-jet image forming apparatus of FIG. 3 according to other embodiments of the present general inventive concept;

FIGS. 11 through 17 are views illustrating other embodiments of the present general inventive concept in which a position of a compensating nozzle unit is different from a position illustrated in the embodiments of FIGS. 4 through 10.

FIG. 18 is a block diagram illustrating an apparatus to compensate for a defective nozzle according to an embodiment of the present general inventive concept;

FIG. 19 is a flowchart illustrating a method of compensating for a defective nozzle according to an embodiment of the present general inventive concept;

FIGS. 20A through 20C are views illustrating a process of compensating for a defective nozzle according to an embodiment of the present general inventive concept; and

FIGS. 21A through 21C are views illustrating a process of compensating for a defective nozzle according to another embodiment of the present general inventive concept.

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept by referring to the figures.

FIG. 3 is a schematic view illustrating an ink-jet image forming apparatus according to an embodiment of the present general inventive concept.

Referring to FIG. 3, the ink-jet image forming apparatus includes a paper feeding cassette 120, a pickup roller 117, a printhead unit 105 having a printhead 111 and a nozzle unit 112, a support member 114 disposed opposite to the printhead unit 105, a detecting unit 132 to detect a defective nozzle, a recording medium transferring unit including the pickup roller 117, a feeding roller 115, and a deliver roller 113 to convey a recording medium P in a first direction, and a stacking unit 140 to deliver and stack the recording medium R

The recording medium P is loaded in the paper feeding cassette 120. The recording medium P that is loaded in the paper feeding cassette 120 is conveyed to the printhead 111 by the recording medium transferring units 117 (the pick-up roller), 115 (the feeding roller), and 113 (the deliver roller). The recording medium P may be conveyed in the first direction (i.e., the x-axis direction) whereas a second direction (i.e., the y-axis direction) indicates a widthwise direction of the recording medium P. The first direction and the second direction may be perpendicular to each other. Alternatively, the first direction and second direction may be inclined with respect to each other at a desired angle.

The recording medium transferring units 117, 115 and 113 convey the recording medium P loaded in the paper feeding cassette 120 along a transfer path. The pickup roller 117, the feeding roller 115, and the deliver roller 113, which form the recording medium transferring unit described above, are driven by a driving source 131 (e.g., a motor) to provide a conveying force to convey the recording medium P. The operation of the driving source 131 is controlled by a controller 130.

The pickup roller 117 is installed on one side of the paper feeding cassette 120, and picks up and feeds sheets of the recording medium P loaded in the paper feeding cassette 120 one by one. The pickup roller 117 rotates, while pressing against an upper surface of the recording medium P, such that the recording medium P is conveyed outward out of the paper feeding cassette 120.

The feeding roller 115 is installed at an inlet side of the printhead 111, and conveys the recording medium P, which is fed by the pickup roller 117, to the printhead 111. The feeding roller 115 may align the recording medium P before the recording medium P passes through the printhead 111 such that ink droplets are ejected on a desired portion of the recording medium P. The feeding roller 115 includes a driving roller 115A to provide the conveying force to convey the recording medium P, and an idle roller 115B resiliently disposed against the driving roller 115A. The feeding roller 115 may also include a pair of auxiliary rollers 116 displaced between the pickup roller 117 and the feeding roller 115 to convey the recording medium P.

The delivery roller 113 is installed at an outlet side of the printhead 111, and delivers the recording medium having an image printed thereon out of the image forming apparatus. The recording medium P delivered from the image forming apparatus is stacked on the stacking unit 140. The delivery roller 113 may include a star wheel 113A installed along the widthwise direction of the recording medium P, and a support roller 113B disposed opposite to the star wheel 113A to support a rear side of the recording medium P. When the recording medium P passes under the nozzle unit 112, the ink droplets are ejected on an upper surface of the recording medium P. Thus, the recording medium P is wet by the ink droplets so that the recording medium P may become wrinkled. The wrinkling may cause the recording medium P to contact a bottom surface of the nozzle unit 112 or a body 110, so that the ink droplets on the recording medium P, which are not yet dried, may be smeared and the image may be contaminated. In addition, there is a possibility that spacing between the recording medium P and the nozzle unit 112 is not maintained a constant. The star wheel 113A conveys the recording medium P downward to prevent the recording medium P from coming in contact with the bottom surface of the nozzle unit 112 or the body 110 and to prevent the spacing between the recording medium P and the nozzle unit 112 from varying. At least a portion of the star wheel 113A may be adapted to protrude from the nozzle unit 112 so that the star wheel 113A contacts the upper surface of the recording medium P along a single point. Since the star wheel 113A contacts the upper surface of the recording medium P along the single point, it is possible to prevent the ink image formed on the upper surface of the recording medium P, which is not yet dried, from being smeared or contaminated. Alternatively, a plurality of star wheels may be installed to smoothly convey the recording medium P. When the plurality of star wheels are installed parallel to the conveying direction of the recording medium P, a plurality of corresponding support rollers may also be provided.

When printing is continuously performed, after a current sheet of the recording medium P is delivered and stacked on the stacking unit 140, a next sheet of the recording medium P is delivered before the ink droplets printed on the upper surface of the current sheet of the recording medium P are dried, which may contaminate a rear surface of the next sheet of the recording medium P. In order to prevent the contamination of the next sheet of the recording medium, a drying unit (not shown) may be further provided.

The support member 114 is disposed under the printhead 111 to maintain the spacing between the nozzle unit 112 and the recording medium P in a desired range, and supports the rear surface of the recording medium P to be conveyed. The spacing between the nozzle unit 112 and the recording medium P may be about 0.5 mm to about 2.5 mm.

A defective nozzle of the nozzle unit 112 provided on the printhead 111 is detected by the detecting unit 132. Herein, a defective nozzle may refer to a missing or malfunctioning nozzle.

The detecting unit 132 may include a first sensor 132A to detect a defective nozzle in the nozzle unit 112 prior to a printing operation, and a second sensor 132B to detect a defective nozzle in the nozzle unit 112 when a printing operation is performed. The first sensor 132A irradiates light directly onto the nozzle unit 112 to determine whether a nozzle is disposed in the nozzle unit 112, whereas the second sensor 132B irradiates light onto the conveying recording medium P to determine whether a defective nozzle failed to ejected ink droplets. The structures and operations of the first and second sensors 132A and 132B may be substantially similar to each other, and thus only the second sensor 132B will be described below.

When the printhead 111 uses a thermal heater to eject ink droplets, the defective nozzle may be a consequence of a short-circuit of the thermal heater, a malfunction of a driving circuit of the thermal heater or an electric component, such as an FET, which may be easily detected. Similarly, when the printhead 111 uses a piezoelectric actuator to eject the ink droplets, the defective nozzle may be a consequence of a defect of the piezoelectric actuator or a problem in a circuit that drives the piezoelectric actuator, which may be easily detected. However, in some cases the defective nozzle is not easily detected.

Since a portion to be printed by the defective nozzle has a lower printing density due to missing dots, the portion may be detected using the detecting unit 132, which may be an optical sensor. In this case, the detecting unit 132 includes a light emitting unit to emit light onto the recording medium P (e.g., a light emitting diode), and a light receiving sensor to receive the light reflected from the recording medium P. An output signal from the light receiving sensor is provided to the controller 130. The defective nozzle may be detected by this operation. The light emitting unit and the light receiving sensor may be integrally or separately configured. The structure and operation of the optical sensor should be known to those skilled in the art, and thus a description thereof will not be provided herein.

The printhead unit 105 prints the image by ejecting the ink droplets on the recording medium P, and includes the body 110, the printhead 111 disposed under the body 110, the nozzle unit 112 provided on the printhead 111, and a carriage 106 on which the body 110 is mounted. The feeding roller 115 is rotatably installed at the inlet side of the nozzle unit 112, whereas the delivery roller 113 is rotatably installed at the outlet side of the nozzle unit 112.

The printhead 111 includes the nozzle unit 112, which uses the thermal heater or the piezoelectric device to eject the ink droplets, and has a high resolution as it is malfunctioned via a semiconductor manufacturing process such as etching, deposition, or sputtering. In addition, the nozzle unit 112 is provided with a number of nozzle arrays to eject the ink droplets on the recording medium P to print the image. The nozzle unit 112 may be adapted to correspond to the width of the recording medium P or to be longer than the width of the recording medium P. The nozzle unit 112 is installed along the second direction of the recording medium P. The printhead 111 may be installed in a direction perpendicular to the first direction of the printhead 111.

Although not shown, the body 110 is provided with a storage space to store the ink. The body 110 includes a chamber to communicate with the respective nozzles and having a mechanism to eject the ink droplets (e.g., a piezoelectric device, a thermally driven heater, or the like), a channel to supply the ink stored in the body 110 (e.g., an orifice), a manifold to supply the ink flowing in through the channel to the chamber (i.e., a common channel), and a restrictor to supply the ink from the manifold to the respective chambers (i.e., a separate channel). These components should be known to those skilled in the art, and thus a description thereof will not be provided.

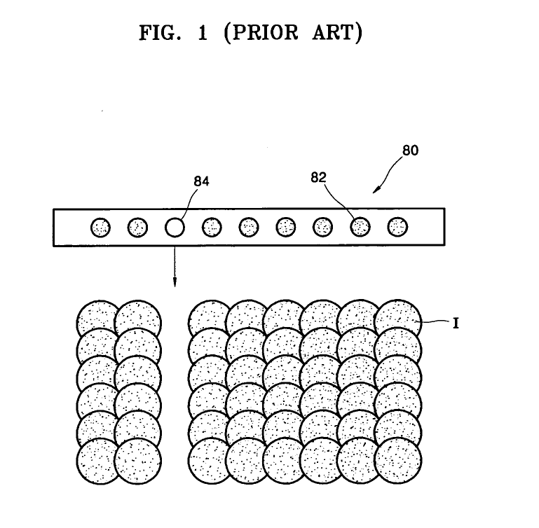

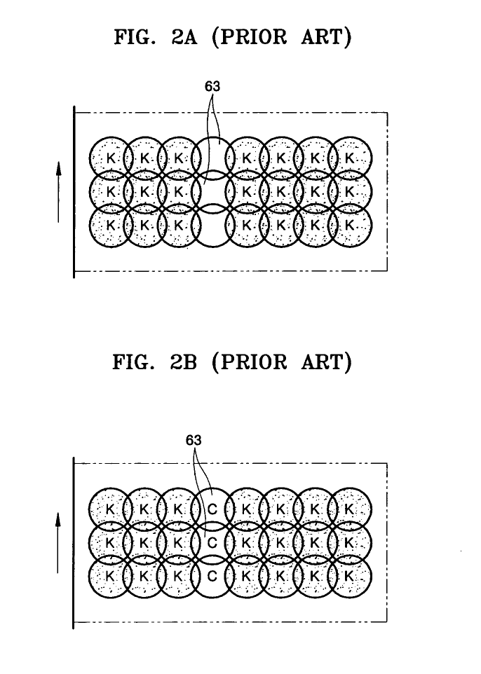

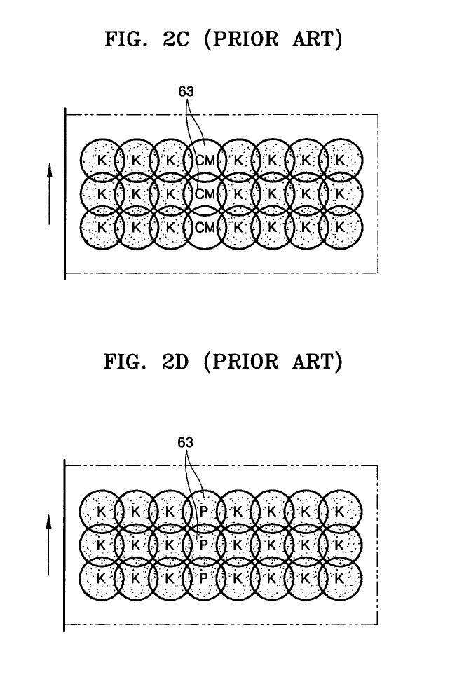

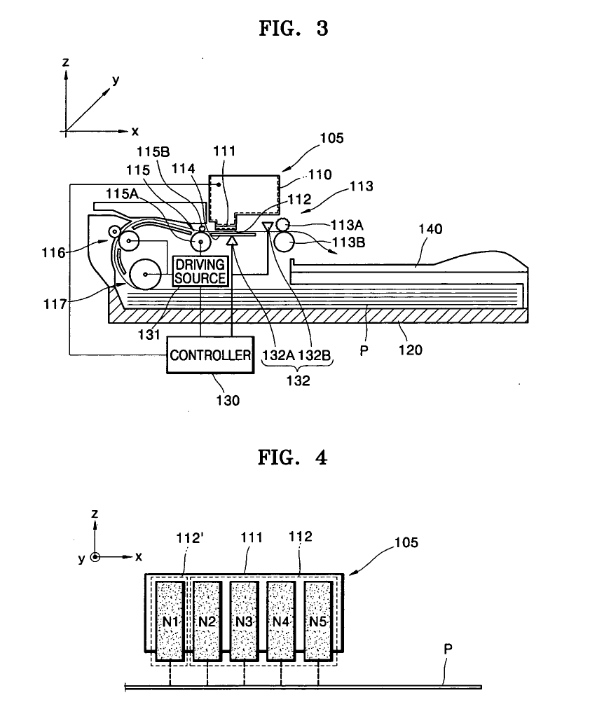

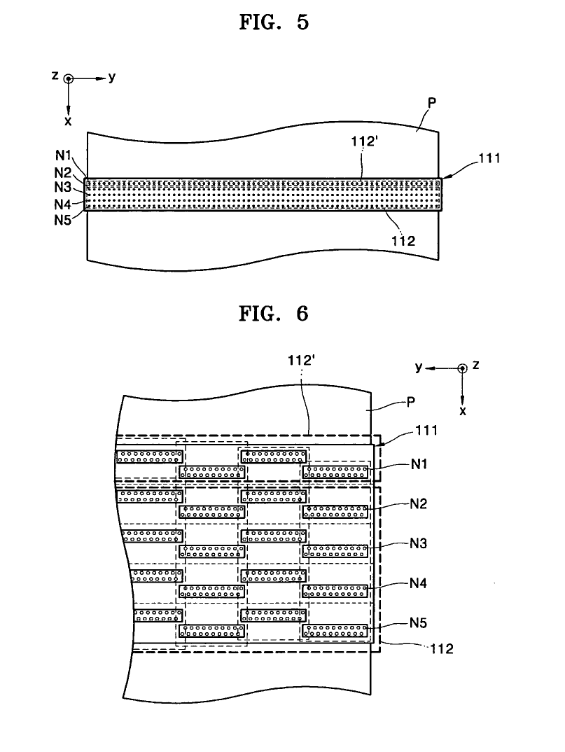

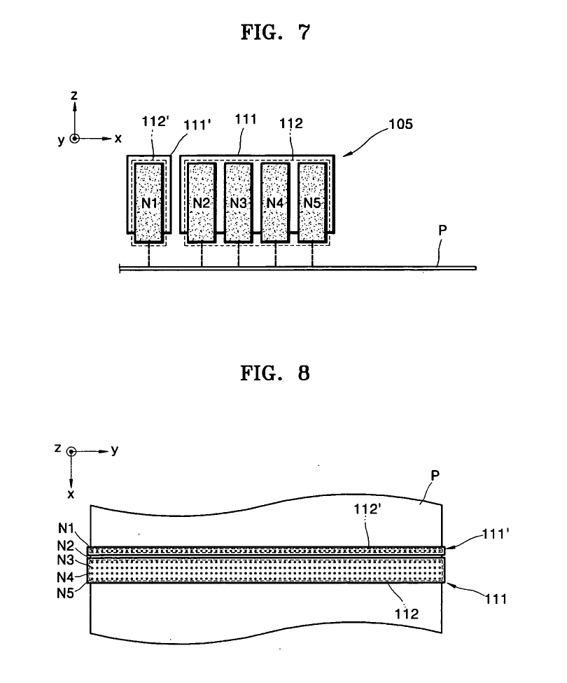

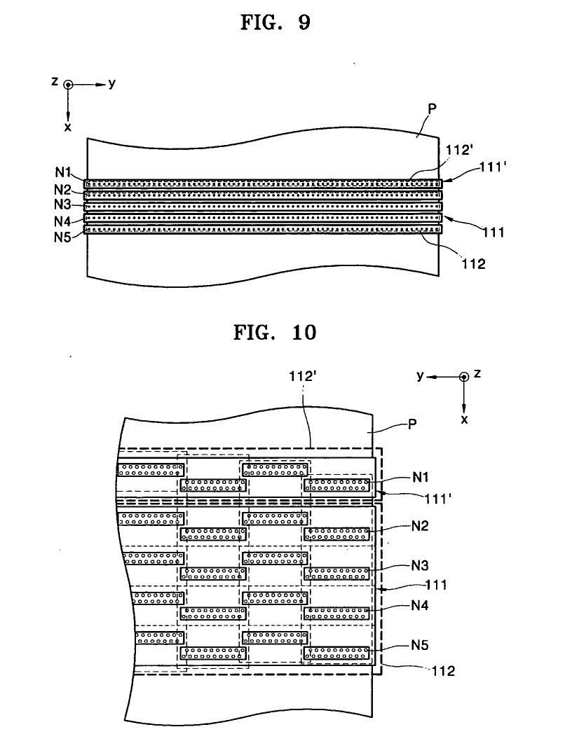

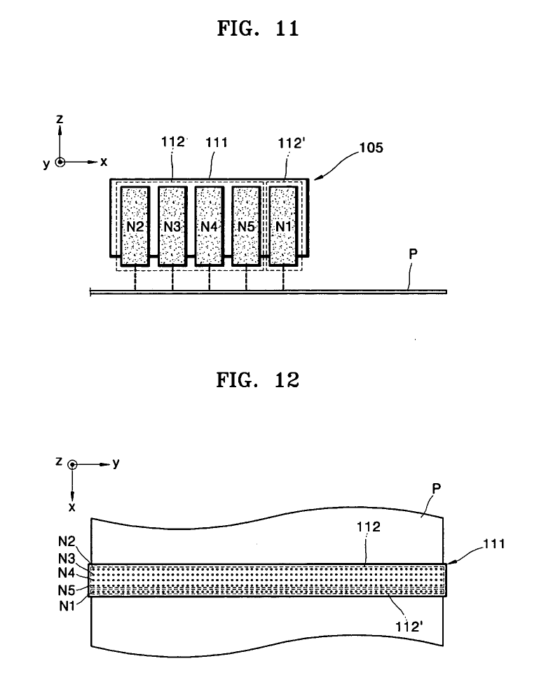

FIG. 4 is a side view illustrating the printhead unit 105 according to an embodiment of the present general inventive concept, and FIG. 5 is a top view illustrating the recording medium P and the printhead unit 105 of FIG. 4 according to an embodiment of the present general inventive concept. FIG. 6 is a top view illustrating the recording medium P and the printhead unit 105 of FIG. 4 according to another embodiment of the present general inventive concept. FIG. 7 is a side view illustrating the printhead unit 105 of FIG. 3 according to another embodiment of the present general inventive concept, and FIG. 8 is a top view illustrating the recording medium P and the printhead unit 105 of FIG. 7 according to an embodiment of the present general inventive concept. FIGS. 9 and 10 are top views illustrating the recording medium P and the printhead unit 105 of FIG. 3 according to other embodiments of the present general inventive concept. Reference numeral 112 indicates a nozzle unit, reference numeral 112′ indicates a compensating nozzle unit, reference numeral 111 indicates a printhead having the nozzle unit 112, and reference numeral 111′ indicates a compensating printhead having the compensating nozzle unit 112′. Like reference numerals as in FIGS. 1 through 3 represent like elements for illustration purposes.

The nozzle unit 112 illustrated in FIGS. 4 and 5 is provided with a number of nozzles in nozzle arrays N2, N3, N4 and N5 to eject the ink droplets in the conveying direction (x-axis direction) of the recording medium P. At least one nozzle of the nozzle unit 112 may eject color ink droplets on the recording medium P to print the image. For the purposes of this description, black may be considered a color. In the present embodiment, the respective nozzle arrays N2, N3, N4 and N5 eject cyan ink droplets, magenta ink droplets, yellow ink droplets, and black ink droplets, respectively, to print a color image. The nozzle unit 112 including the four nozzle arrays N2, N3, N4 and N5, is arranged to have a length that is greater than or equal to the width of the recording medium P. The nozzle unit 112 is controlled by the controller 130.

FIG. 5 illustrates that nozzles can be consecutively arranged in an array, and FIG. 6 illustrates that a number of nozzle groups N1 through N5 can be arranged in a staggered fashion. As described above, the nozzle unit 112 may have various shapes. Other alternative arrangements may also be used and the embodiments illustrated in the figures are not intended to limit the scope of the preset general inventive concept.

If a defective nozzle is detected in the nozzle unit 112 by the detecting unit 132, the compensating nozzle unit 112′ is utilized to compensate for the defective nozzle. Thus, the compensating nozzle unit 112′ ejects a colorless ink droplet (i.e., a colorless fluid droplet) on a portion of the recording medium P at which the defective nozzle would eject ink. One or more ink droplets ejected to a portion that is adjacent to the colorless ink droplet by the nozzle unit 112 are dispersed into the colorless ink droplet ejected by the compensating nozzle unit 112′. As a result of the dispersion, the colorless ink droplet ejected on the recording medium P is changed to the same color as the adjacent ink droplets. The colorless ink droplet may refer to a liquid or fluid that allows easy dispersion of the one or more ink droplets ejected by the nozzle unit 112.

The compensating nozzle unit 112′ may be provided on the printhead 111 with the nozzle unit 112 (see FIGS. 4 through 6), or may be provided on a separate printhead (see FIGS. 7 through 10). The compensating nozzle unit 112′ may have nozzles with a diameter equal to or larger than the nozzles of the nozzle unit 112 in order to properly use the dispersing effect of the adjacent ink droplets when compensating for the defective nozzle. However, if the diameter of the nozzles in the compensating nozzle unit 112′ are too large, a colorless ink droplet that is too large is ejected by the compensating nozzle unit 112′, and ink droplets ejected by other nozzle arrays may be dispersed into the colorless ink droplet. Thus, printing quality may be significantly reduced. Accordingly, the compensating nozzle unit 112′ may have nozzles with a diameter that is less than or equal to two times that of the nozzle unit 112. The compensating nozzle unit 112′ may have a length that is greater than or equal to the width of the recording medium R

As illustrated in FIGS. 4 through 10, the compensating nozzle unit 112′ to eject the colorless ink droplet may be positioned such that the conveying recording medium P passes thereunder before passing under the nozzle unit 112. More specifically, the colorless ink droplet ejected by the compensating nozzle unit 112′ may be printed on the recording medium P prior to the ink droplets ejected by the nozzle unit 112. Thus, when the defective nozzle is detected in the nozzle unit 112 before performing the printing (i.e., when the defective nozzle is detected by the first sensor 132A), the defective nozzle can be compensated for before the nozzle unit 112 ejects the ink droplets. Consequently, after the colorless ink droplet is ejected, a desired color ink droplet is ejected adjacent to the colorless ink droplet to properly compensate for the effect due to the defective nozzle.

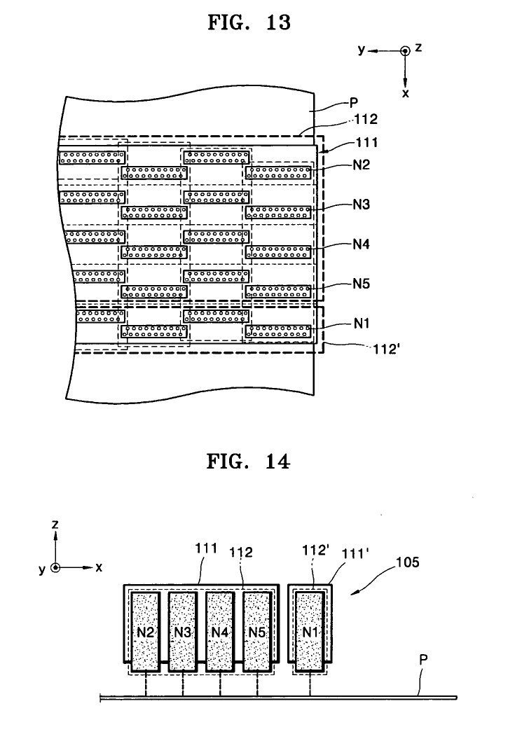

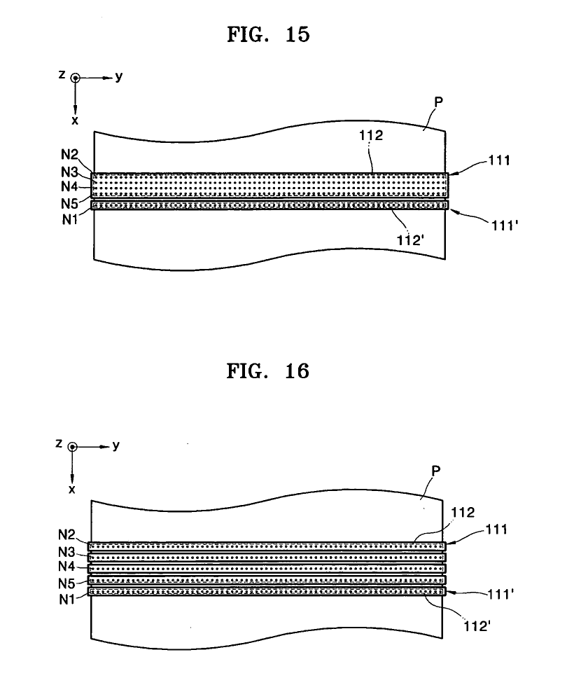

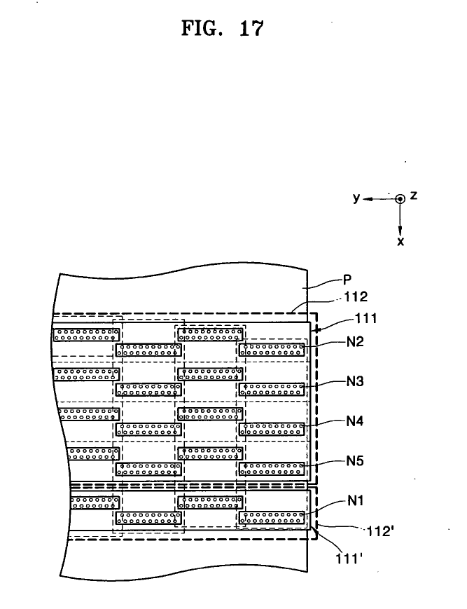

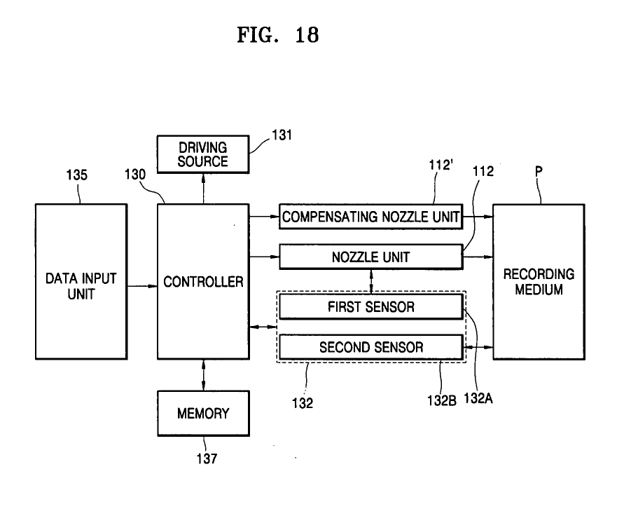

FIGS. 11 through 17 are views illustrating another embodiment of the present general inventive concept in which a position of the compensating nozzle unit 112′ is different from a position illustrated in FIGS. 4 through 10. FIGS. 11 through 17 are similar to FIGS. 4 through 10, except for the position of the compensating nozzle unit 112′, thus a detailed description of some of the components described above will not be provided. As illustrated in FIGS. 11 through 17, the compensating nozzle unit 112′ to eject the colorless ink droplet may be positioned such that the conveying recording medium P passes under the nozzle unit 112 before passing under the compensating nozzle unit 112. More specifically, the colorless ink droplet ejected by the compensating nozzle unit 112′ may be printed on the recording medium P after the nozzle unit 112 ejects the ink droplet. Thus, when the defective nozzle is detected in the nozzle unit 112 during the printing operation (i.e., when the defective nozzle is detected by the second sensor 132B) the defective nozzle is compensated for at the time the defective nozzle is detected. That is, even after the defective nozzle fails to print to (i.e., eject ink droplets to) some portions of the recording medium, the defective nozzle may be compensated for immediately at the time it is detected, thereby minimizing the deterioration of the printing quality due to the defective nozzle. Although not shown, the second sensor 132B may be interposed between the nozzle unit 112 and the compensating nozzle unit 112′. Accordingly, the second sensor 132B can aid the compensating nozzle unit 112′ to more effectively compensate for the defective nozzle.

The compensating nozzle unit 112′ and the nozzle unit 112 may be formed on the same head chip (see FIGS. 5, 6, 12, and 13), or may be formed on separate head chips (see FIGS. 8, 9, 10, 15, 16, and 17), through a process of manufacturing a semiconductor device.

A number of head chips on which the compensating nozzle unit 112′ and the nozzle unit 112 are formed may be staggered along the widthwise direction of the recording medium P.

FIG. 18 is a block diagram illustrating an apparatus to compensate for a defective nozzle according to an embodiment of the present general inventive concept. Some of the components of the apparatus of FIG. 18 are similar to components of the previous embodiment(s). Accordingly, the same reference numerals are used to represent these similar components. Referring to FIG. 18, a data input unit 135 receives image data to be printed from an external device, such as a personal computer, a digital camera, or a personal digital assistant, in an order of printing pages.

The controller 130 may be mounted on a mother board of the image forming apparatus to control an ejecting operation of the nozzle unit 112 provided on the printhead 111, a conveying operation of the recording medium transferring units 117, 115 and 113, and a conveying operation of a carriage transferring unit. In particular, the controller 130 initiates the operations of the respective elements so that the ink droplets ejected by the nozzle unit 112 may be printed on the desired portion of the recording medium P Also, the controller 130 stores the image data which is input through the data input unit 135 in a memory 137, and determines whether the image data of a page to be printed is stored in the memory 137. If the image data has been completely stored, the controller 130 operates the driving source 131 so that the recording medium P is conveyed by the recording medium transferring units 117, 115 and 113 driven by the driving source 131.

If a defective nozzle is not detected, the controller 130 operates the nozzle unit 112 to eject the ink droplets when the recording medium P enters (i.e., passes under) the nozzle unit 112. The controller 130 outputs control signals to control the operation of the nozzle unit 112 to print the image data on the recording medium P. The nozzle unit 112 receives the control signals from the controller 130 to print the image data on the recording medium P.

If a defective nozzle is detected, the controller 130 outputs control signals to control an operation of the compensating nozzle unit 112′ so that the colorless ink droplet is printed at the position where the ink droplet should be ejected by the defective nozzle. The compensating nozzle unit 112′ receives the control signals from the controller 130 to eject the colorless ink droplet on the recording medium P from the controller 130. The ink droplet ejected by the nozzle unit 112 is dispersed into the colorless ink droplet, and the colorless ink droplet is changed into the same color as that of the adjacent ink droplet color through the dispersion, thereby compensating for the deterioration of the printing quality that would result from the defective nozzle.

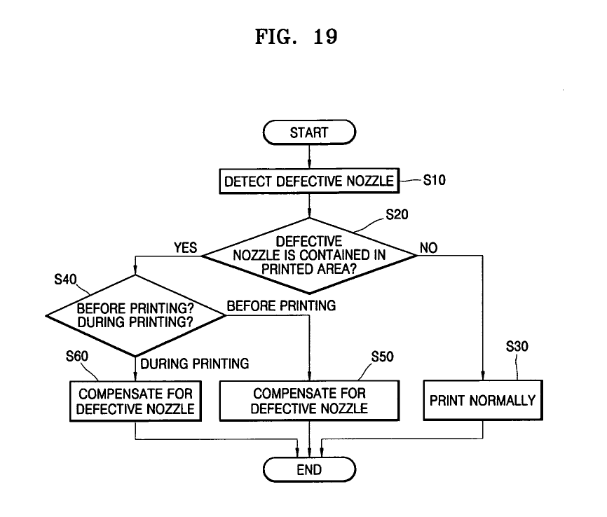

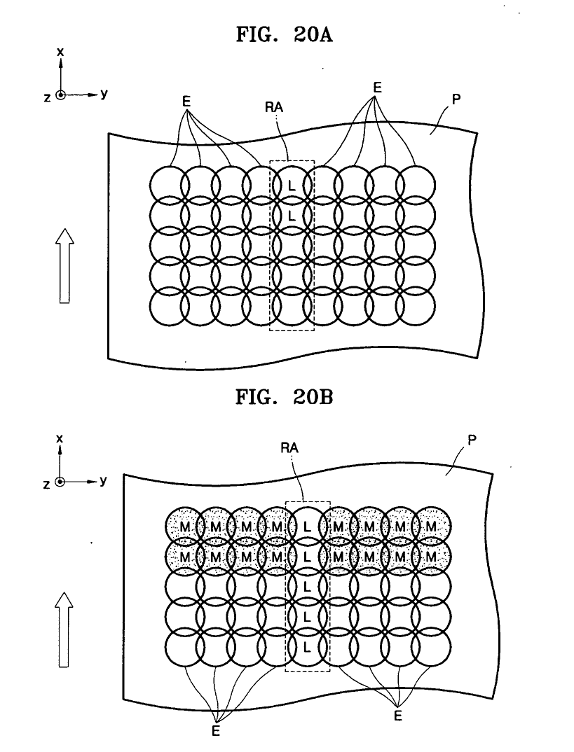

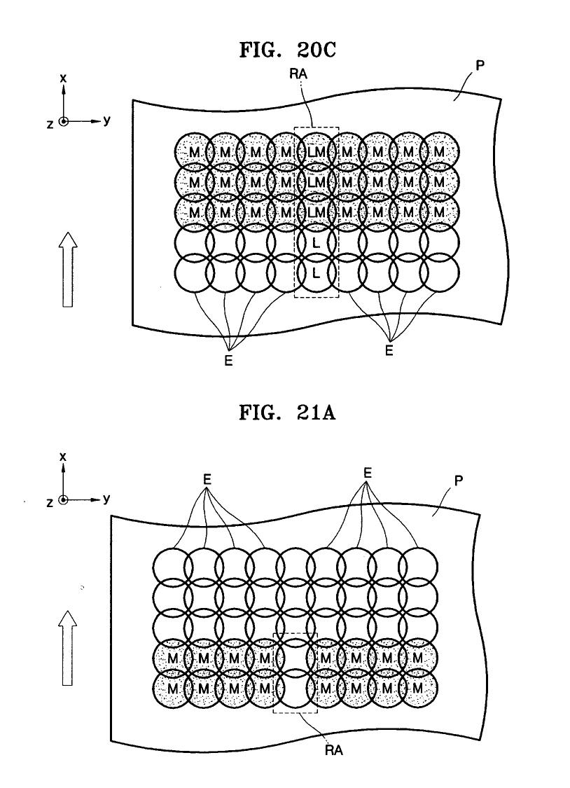

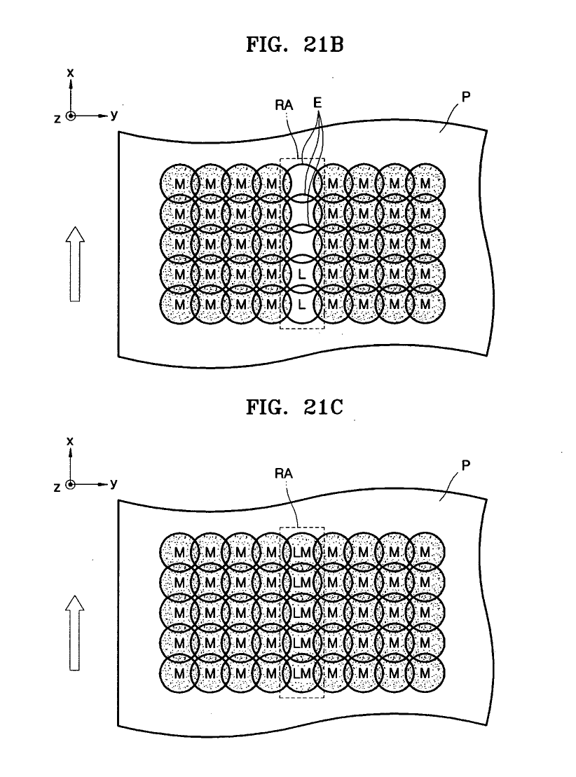

FIG. 19 is a flowchart illustrating a method of compensating for a defective nozzle according to an embodiment of the present general inventive concept. The method of FIG. 19 may be performed in the image forming apparatus of FIG. 3 and/or the apparatus of FIG. 18 including the printhead 111, the compensating printhead 111′, the nozzle unit 112, and the compensating nozzle unit 112′ of the previous embodiments. Accordingly, the method of FIG. 19 is described below with reference to FIGS. 3 through 18. FIGS. 20A through 20C are views illustrating a process of compensating for a defective nozzle according to an embodiment of the present general inventive concept. The process illustrated in FIGS. 20A through 20C may be carried out by performing the method of FIG. 19. FIGS. 21A through 21C are views illustrating a process of compensating for a defective nozzle according to another embodiment of the present general inventive concept. The process illustrated in FIGS. 21A through 21C may also be carried out by performing the method of FIG. 19. For illustration purposes, the case in which a defective nozzle is detected in the nozzle unit 112 to eject a magenta ink droplet is described in this embodiment. In FIGS. 20A through 21C, reference numeral E indicates a position where the ink droplet is ejected by the nozzle unit 112, reference numeral RA indicates a position where the colorless ink droplet is ejected by the compensating nozzle unit 112′, reference numeral L indicates the colorless ink droplet, reference numeral LM indicates a dot at which the magenta ink droplet is dispersed to the colorless ink droplet, and reference numeral P indicates the recording medium. The recording medium P is conveyed in an arrow direction.

Referring to FIG. 19, the method of compensating for a defective nozzle according to an embodiment of the present general inventive concept includes detecting a defective nozzle in the nozzle unit 112 (operation S10), and compensating for the defective nozzle (operations S50 and S60). The operations of compensating for the defective nozzle (the operations S50 and S60) are performed via the compensating nozzle unit 112′ by ejecting the colorless ink droplet L. The operation of detecting the defective nozzle in the nozzle unit (the operation S10) is described above.

The method of compensating for the defective nozzle further includes determining whether a region (or position) to be printed corresponds to the defective nozzle (operation S20). If the region to be printed does not correspond to the defective nozzle, printing is performed normally (operation S30). If the region to be printed corresponds to the defective nozzle, a compensation printing operation is performed to compensate for a missing or white line that would appear in the printed image due to the defective nozzle.

A case in which the defective nozzle is detected by irradiating light onto the nozzle unit 112 prior to performing the printing operation (i.e., a normal printing operation) (operation S40) will now be described. As illustrated in FIG. 20A, if the defective nozzle is detected prior to performing the printing operation (i.e., the normal printing operation), the colorless ink droplet L is ejected on the portion (i.e., the region RA) that corresponds to the defective nozzle before the image is printed in the normal printing operation. As the recording medium P with the colorless ink droplet is continuously moved in the arrow direction, the magenta ink droplet M is printed on the recording print P by the nozzle unit 112 to adjacent regions, as illustrated in FIG. 20B. As the printing operation is continuously performed, the adjacent magenta ink droplet M is dispersed to the colorless ink droplet L, as illustrated in FIG. 20C. The colorless ink droplet L printed on the recording medium P through the above process is changed into the magenta dot of ink LM.

Hence, as opposed to the prior art in which a white line appears on the printed image due to a defective nozzle, the various embodiments of the present general inventive concept can compensate for the deterioration of the printing quality that would occur due to the defective nozzle by dispersing the adjacent ink droplet(s) M into the colorless ink droplet L, thereby coloring the colorless ink droplet the same color as that of the adjacent ink droplet.

Referring to FIGS. 18, 19, and 21A through 21C, the case in which a defective nozzle is detected by irradiating light onto the recording medium P during the printing operation (the operation S40) will now be described. The nozzle unit 112 ejects the ink droplets on the recording medium P to print the image. When the defective nozzle is detected during the printing operation, the region RA on which the ink droplet is not printed due to the defective nozzle appears as illustrated in FIG. 21A. When the region RA without the ink droplet printed thereon is detected by the detecting unit 132, the compensating nozzle unit 112′ ejects the colorless ink droplet L on the region RA, as illustrated in FIG. 21B. While printing is being continuously performed, the adjacent magenta ink droplet M is dispersed to the colorless ink droplet L, as illustrated in FIG. 21C. Accordingly, the colorless ink droplet L printed on the recording medium P through the above process is changed into the magenta dot LM by dispersion.

Hence, as opposed to the prior art in which a white line appears on the printed image due to a defective nozzle, the various embodiments of the present general inventive concept can compensate for the deterioration of the printing quality by dispersing the adjacent ink droplet M into the colorless ink droplet L thereby coloring the colorless ink droplet L the same color as that of the adjacent ink droplet M. When the defective nozzle is detected during the printing operation, the missing or white line appears on the printed image. The compensating nozzle unit 112′ may be arranged such that the recording medium P does not pass thereunder before passing under the nozzle unit 112, or the second sensor 132B may be interposed between the nozzle unit 112 and the compensating nozzle unit 112′, thereby minimizing the occurrence of the missing line.

In the above-described method according to the present embodiment, a missing dot (or line) created by a defective nozzle can be properly compensated for using the compensating nozzle unit 112′ to eject a colorless ink droplet L. In addition, in the present embodiment, the sizes (e.g., diameters) of the nozzles and the arrangement of the compensating nozzle units 112′ are properly regulated to minimize the occurrence of a missing line.

Although not illustrated, the missing dot (or line) can be effectively compensated for by forming a nozzle in the compensating nozzle unit 112′ to have an elliptical shape with a major axis extending along the widthwise direction of the recording medium P. Accordingly, the colorless ink droplet L may be ejected to have the elliptical shape to overlap with circular color ink droplets (e.g., M) ejected by the nozzle unit 112.

As described above, unlike the prior art, in a method of compensating for a defective nozzle in an ink-jet image forming apparatus according to the various embodiments of the present general inventive concept, a printing defect, such as a white line that can be easily noticed by a user, can be compensated for using colorless ink droplets. In addition, unlike the prior art, a defective nozzle that ejects color ink as well as a defective nozzle that ejects black ink can be compensated for. According to the various embodiments of the present general inventive concept, a compensation effect can be improved by adjusting the sizes of nozzles and/or an arrangement of the nozzles in a compensating nozzle unit. In addition, according to the various embodiments of the present general inventive concept, ink consumption is reduced because black ink or other color ink is not used for compensation. Also, a lifespan of an ink-jet head unit is extended. Furthermore, according to the various embodiments of the present general inventive concept, the compensation effect can be improved using bleeding of ejected ink droplets, rather than preventing the bleeding of ink droplets as in the prior art.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. A method of compensating for a defective nozzle in an ink-jet image forming apparatus having a nozzle unit to eject an ink droplet on a recording medium, the method comprising:
detecting the defective nozzle in the nozzle unit; and
if the defective nozzle is detected, compensating for the defective nozzle by using a compensating nozzle unit to eject a colorless ink droplet.

2. The method according to claim 1, wherein the detecting of the defective nozzle is performed prior to a printing operation performed by the nozzle unit.

3. The method according to claim 2, wherein light is irradiated on the nozzle unit to detect the defective nozzle.

4. The method according to claim 2, wherein the compensating of the defective nozzle comprises ejecting the colorless ink droplet from the compensating nozzle unit on a portion of the recording medium that corresponds to the defective nozzle before the printing operation is performed by the nozzle unit.

5. The method according to claim 4, wherein the compensating nozzle unit includes a plurality of nozzles having diameters that are greater than or equal to diameters of a plurality of nozzles in the nozzle unit.

6. The method according to claim 4, wherein the compensating nozzle unit includes a plurality of nozzles having diameters that are less than or equal to two times the diameters of a plurality of nozzles in the nozzle unit.

7. The method according to claim 4, wherein the compensating nozzle unit and the nozzle unit are formed on a single chip.

8. The method according to claim 7, wherein the compensating nozzle unit is arranged such that the recording medium passes thereunder before passing under the nozzle unit as the recording medium is being conveyed.

9. The method according to claim 4, wherein the compensating nozzle unit and the nozzle unit are formed on separate chips.

10. The method according to claim 9, wherein the compensating nozzle unit is arranged such that the recording medium passes thereunder before passing under the nozzle unit as the recording medium is being conveyed.

11. The method according to claim 4, wherein the nozzle unit has a length that is greater than or equal to a width of the recording medium.

12. The method according to claim 4, wherein the compensating nozzle unit has a length that is greater than or equal to a width of the recording medium.

13. The method according to claim 1, wherein the detecting of the defective nozzle is performed during a printing operation performed by the nozzle unit.

14. The method according to claim 13, wherein light is irradiated on the recording medium to detect the defective nozzle.

15. The method according to claim 13, wherein the compensating for the defective nozzle comprises ejecting the colorless ink droplet from the compensating nozzle unit while the printing operation is performed and before a color ink droplet would have been ejected on a portion of the recording medium corresponding to the defective nozzle.

16. The method according to claim 15, wherein a plurality of nozzles in the compensating nozzle unit have diameters that are greater than or equal to diameters of a plurality of nozzles of the nozzle unit.

17. The method according to claim 16, wherein the plurality of nozzles in the compensating nozzle unit have diameters that are less than or equal to two times the diameters of the plurality of nozzles of the nozzle unit.

18. The method according to claim 15, wherein the compensating nozzle unit and the nozzle unit are formed on a single chip.

19. The method according to claim 18, wherein the compensating nozzle unit is arranged such that the recording medium passes under the nozzle unit before passing under the compensating nozzle unit as the recording medium is being conveyed.

20. The method according to claim 15, wherein the compensating nozzle unit and the nozzle unit are formed on separate chips.

21. The method according to claim 20, wherein the compensating nozzle unit is arranged such that the recording medium passes under the nozzle unit before passing under the compensating nozzle unit as the recording medium is being conveyed.

22. The method according to claim 20, wherein a detecting unit that irradiates the light on the recording medium to detect the defective nozzle is interposed between the nozzle unit and the compensating nozzle unit.

23. A method of compensating for a defective nozzle in a nozzle unit, the method comprising:
ejecting a colorless fluid droplet to a position on a recording medium that corresponds to the defective nozzle; and
ejecting a color ink droplet adjacent to the position corresponding to the defective nozzle such that the colorless fluid droplet and the color ink droplet bleed together.

24. An apparatus to compensate for a defective nozzle in an ink-jet image forming device having a nozzle unit to eject an ink droplet on a recording medium, the apparatus comprising:
a detecting unit to detect the defective nozzle in the nozzle unit; and
a compensating nozzle unit to eject a colorless ink droplet to compensate for the defective nozzle when the defective nozzle is detected in the nozzle unit.

25. The apparatus according to claim 24, wherein the detecting unit detects the defective nozzle before a printing operation is performed by the nozzle unit by irradiating light on the nozzle unit to detect the defective nozzle.

26. The apparatus according to claim 24, wherein the compensating nozzle unit ejects the colorless ink droplet on a portion of the recording medium that corresponds to the defective nozzle before the printing operation is performed by the nozzle unit.

27. The apparatus according to claim 24, wherein the compensating nozzle unit includes a plurality of nozzles having diameters that are greater than or equal to diameters of a plurality of nozzles in the nozzle unit.

28. The apparatus according to claim 24, wherein the compensating nozzle unit comprises a plurality of nozzles having elliptical shapes.

29. The apparatus according to claim 24, wherein the compensating nozzle unit includes a plurality of nozzles having diameters that are less than or equal to two times diameters of a plurality of nozzles in the nozzle unit.

30. The apparatus according to claim 24, wherein the compensating nozzle unit is arranged such that the recording medium passes thereunder before passing under the nozzle unit as the recording medium is being conveyed.

31. The apparatus according to claim 24, wherein the nozzle unit and the compensating nozzle unit have lengths that are greater than or equal to a width of the recording medium.

32. The apparatus according to claim 24, wherein the detecting unit detects the defective nozzle during a printing operation performed by the nozzle unit by irradiating light on the recording medium to sense an image density of the recording medium.

33. The apparatus according to claim 24, wherein the compensating nozzle unit ejects the colorless ink droplet while the printing operation is performed by the nozzle unit and before a color ink droplet would have been ejected by the nozzle unit to a portion that corresponds to the defective nozzle.

34. The apparatus according to claim 24, wherein the compensating nozzle unit and the nozzle unit are formed on a single chip.

35. The apparatus according to claim 24, wherein the compensating nozzle unit is arranged such that the recording medium passes under the nozzle unit before passing under the compensating nozzle unit as the recording medium is being conveyed.

36. The apparatus according to claim 24, wherein the compensating nozzle unit and the nozzle unit are formed on separate chips.

37. The apparatus according to claim 24, wherein the detecting unit irradiates the light on the recording medium to detect the defective nozzle and is interposed between the nozzle unit and the compensating nozzle unit.

38. An apparatus to compensate for a defective nozzle in a nozzle unit of an inkjet image forming device, the apparatus comprising:
a compensating nozzle unit to eject a colorless fluid droplet to a position on a recording medium that corresponds to the defective nozzle, and the nozzle unit ejects at least one color ink droplet adjacent to the position corresponding to the defective nozzle such that the colorless fluid droplet and the at least one color ink droplet bleed together.

39. The apparatus according to claim 38, wherein the compensating nozzle unit ejects the colorless fluid droplet to the position before the position would have been printed to by the defective nozzle.

40. The apparatus according to claim 38, wherein the compensating nozzle unit ejects the colorless fluid droplet to the position after the position would have been printed to by the defective nozzle.

41. The apparatus according to claim 38, wherein the at least one color ink droplet ejected by the nozzle unit comprises at least two color ink droplets ejected on two sides of the colorless fluid droplet to overlap therewith to cause dispersion.

42. An inkjet image forming apparatus, comprising:
a nozzle unit having a plurality of nozzles to perform a normal printing operation; and
a compensating nozzle unit disposed adjacent to the nozzle unit and having a plurality of nozzles to perform a compensating printing operation by ejecting a colorless fluid droplet to a position on a recording medium that corresponds to a defective nozzle in the nozzle unit, wherein the nozzle unit ejects at least one color ink droplet adjacent to the position corresponding to the defective nozzle such that the colorless fluid droplet and the color ink droplet bleed together.

43. The inkjet image forming apparatus according to claim 42, further comprising:
a detecting unit to detect the defective nozzle before the normal printing operation is performed by the nozzle unit by irradiating light on a bottom surface of the nozzle unit and detecting reflected light.

44. The inkjet image forming apparatus according to claim 42, further comprising:
a detecting unit to detect the defective nozzle during the normal printing operation by irradiating light to the recording medium and detecting reflected light to determine whether one of a missing line and a missing dot exists on the recording medium.

45. The inkjet image forming apparatus according to claim 42, further comprising:
a body having a bottom surface on which the nozzle unit and the compensating nozzle unit are disposed; and
a detecting unit disposed between the nozzle unit and the compensating nozzle unit on the bottom surface of the body to detect the defective nozzle by irradiating light to the recording medium.

46. The inkjet image forming apparatus according to claim 42, further comprising:
a detecting unit to detect the defective nozzle in the nozzle unit; and
a controller to receive one or more input signals from the detecting unit and to apply control signals to the nozzle unit and the compensating nozzle unit.

47. An inkjet image forming apparatus, comprising:
a nozzle unit having a plurality of nozzles to eject color ink to a recording medium; and
a compensation unit to perform a dispersion operation to the ejected color ink on the recording medium to compensate for a defective nozzle in the nozzle unit, when the nozzle unit includes a defective nozzle.
